(19) United States
(12) Patent Application Publication
(10) Pub. No.: US 2015/0101461 A1
(43) Pub. Date: Apr. 16, 2015

(54) DRIVING TOOL COMBINATION

(71) Applicant: Yi Cheng LI, Taichung (TW)

(72) Inventor: Yi Cheng LI, Taichung (TW)

(73) Assignee: Yi Cheng LI, Taichung (TW)

(21) Appl. No.: 14/051,501

(22) Filed: Oct. 11, 2013

(51) Int. Cl. B25G 1/04; B25G 1/00; B25G 1/06

(52) U.S. Cl. CPC B25G 1/043; B25G 1/063; B25G 1/007
USPC 81/438; 81/177.7; 81/121.1

(57) ABSTRACT

A driving tool combination includes a driving tool shank having a non-circular engaging hole formed in one end and a notch formed in the other end, a driving adapter attached to the driving tool shank with a pivot shaft and having a non-circular driving stud, a driving member having a non-circular engaging hole for engaging with the driving stud, a spring-biased projection engaged in the driving tool shank for anchoring the driving adapter to the driving tool shank, and a driving tool device includes a driving stem having a non-circular driving head for engaging with the driving tool shank and for allowing the driving tool shank to be rotated and driven by the driving stem of the driving tool device.

### BACKGROUND OF THE INVENTION

1. Field of the Invention

The present invention relates to a driving tool extension or combination, and more particularly to a driving tool extension or combination including an improved structure or configuration for easily and readily and effectively rotating or driving or operating the fasteners or other tool extensions or members or the like.

2. Description of the Prior Art

Various kinds of typical driving tool extensions or combinations have been developed and provided for operating or rotating or driving various fasteners or tool extensions or members or the like and comprise a tool extension or rod member including one end portion to be engaged with the fasteners or tool extensions or members and the other end portion to be engaged with the other driving tool devices for being driven or rotated by the driving tool devices.

For example, U.S. Pat. No. 4,334,445 to Timewell, U.S. Pat. No. 6,145,413 to Lin, U.S. Pat. No. 6,412,373 to Hsiao, U.S. Pat. No. 6,874,392 to Wu, U.S. Pat. No. 6,976,411 to Yu, U.S. Pat. No. 7,018,298 to Chiou, U.S. Pat. No. 7,363,839 to Chiang, and U.S. Pat. No. 7,444,908 to Lin disclose several of the typical driving tool extensions or combinations each also comprising a tool extension or rod member including one end portion for engaging with and for driving or rotating the fasteners or tool extensions or members, and the other end portion for engaging with the other driving tool devices and for being driven or rotated by the driving tool devices.

However, the fasteners or tool extensions or members may not be easily and readily and effectively rotated or driven by the driving tool devices with the typical driving tool extensions or combinations, and the other tool extensions or members may further be required to be provided or disposed or engaged with the fasteners and the driving tool devices for allowing the other fasteners or tool extensions or members to be suitably driven or rotated by the driving tool devices.

The present invention has arisen to mitigate and/or obviate the afore-described disadvantages of the conventional driving tool extensions or combinations.

### SUMMARY OF THE INVENTION

The primary objective of the present invention is to provide a driving tool extension or combination including an improved structure or configuration for easily and readily and effectively rotating or driving or operating the fasteners or other tool extensions or members or the like.

In accordance with one aspect of the invention, there is provided a driving tool combination comprising a driving tool shank including a first end portion and a second end portion, and including a non-circular engaging hole formed in the first end portion of the driving tool shank, and including a notch formed in the second end portion of the driving tool shank for forming and defining a first flap and a second flap, the notch of the driving tool shank being located between the flaps, the driving tool shank including a through hole formed in the first flap and communicating with the notch of the driving tool shank, and including a screw hole formed in the second flap and communicating with the notch of the driving tool shank and aligned with the through hole of the driving tool shank, and including a cavity formed in the driving tool shank and located between the flaps and communicating with the notch of the driving tool shank, a pivot shaft engaged in the through hole of the first flap of the driving tool shank, and including a threaded end portion engaged with the screw hole of the second flap of the driving tool shank for attaching the pivot shaft to the flaps of the driving tool shank, a driving adapter including an orifice formed in a first end portion thereof for receiving and engaging with the pivot shaft and for pivotally mounting the driving adapter to the second end portion of the driving tool shank and for allowing the driving adapter to be rotated relative to the driving tool shank, and including a recess formed in the first end portion of the driving adapter, the driving adapter including a non-circular driving stud, a driving member including a non-circular engaging hole formed therein for engaging with the non-circular driving stud and for allowing the driving member to be rotated and driven by the driving stud, the driving stud including a spring-biased detent for engaging with the driving member and for anchoring the driving member to the driving adapter, a spring-biased projection engaged in the cavity of the driving tool shank and extendible into the notch of the driving tool shank for engaging with the recess of the driving adapter and for anchoring the driving adapter to the driving tool shank at a selected position, and a driving tool device including a driving stem having a non-circular driving head provided on a first end portion of the driving stem for selectively engaging with the engaging hole of the driving tool shank and for allowing the driving tool shank to be pivoted or rotated and driven by the driving stem of the driving tool device.

The driving tool device includes a hand grip provided on a second end portion of the driving stem for holding and rotating or driving the driving stern. The driving tool device includes an engaging aperture formed in a second end portion of the driving stern, and a driving tool mechanism includes a driver shank for engaging with the engaging aperture of the driving tool device for rotating or driving the driving tool device. The driving tool mechanism is selected from a driving wrench.

The driving member is selected from a socket member or the like. The socket member includes a hexagonal socket opening formed in the socket member for engaging with a fastener or driven element, or includes a screw bit provided on the socket member for engaging with a screw, or includes a hexagonal driving stud provided on the socket member for engaging with a fastener or driven element.

The driving tool device includes at least one longitudinal groove formed in a second end portion of the driving stem for forming and defining at least one longitudinal rib on the second end portion of the driving stem and for being frictionally engaged with and gripped or grasped or held by the user and for allowing the driving stem of the driving tool device to be effectively driven or rotated by the user with the rib and/or the groove of the driving stem of the driving tool device.

The driving tool shank includes a narrowed neck portion formed between the first and the second end portions of the driving tool shank, and the narrowed neck portion of the driving tool shank includes a ratio of a length of the narrowed neck portion to an outer diameter of the narrowed neck portion less than five.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a driving tool extension or combination in accordance with the present invention;

FIG. 2 is another partial exploded view of the driving tool extension or combination;

FIG. 3 is a side plan schematic view of the driving tool extension or combination, in which a portion of the driving tool extension or combination has been cut off for showing the inner structure of the driving tool extension or combination;

FIG. 4 is another side plan schematic view of the driving tool extension or combination;

FIGS. 5, 6, 7, 8, 9, 10 are plan schematic views illustrating the operation or formation of the tool shank of the driving tool extension or combination;

FIGS. 11, 12, 13, 14, 15, 16 are end plan schematic views of the tool shanks as shown in FIGS. 5, 6, 7, 8, 9, 10 respectively;

FIGS. 17, 18 are other side plan schematic views similar to FIG. 3, illustrating the operation of the driving tool extension or combination;

FIG. 19 is a further side plan schematic view similar to FIGS. 3, 4, 17, 18 illustrating the other arrangement of the driving tool extension or combination; and

FIG. 20 is a further partial exploded view illustrating the further arrangement of the driving tool extension or combination.

### DETAILED DESCRIPTION OF THE PREFERRED EMBODIMENT

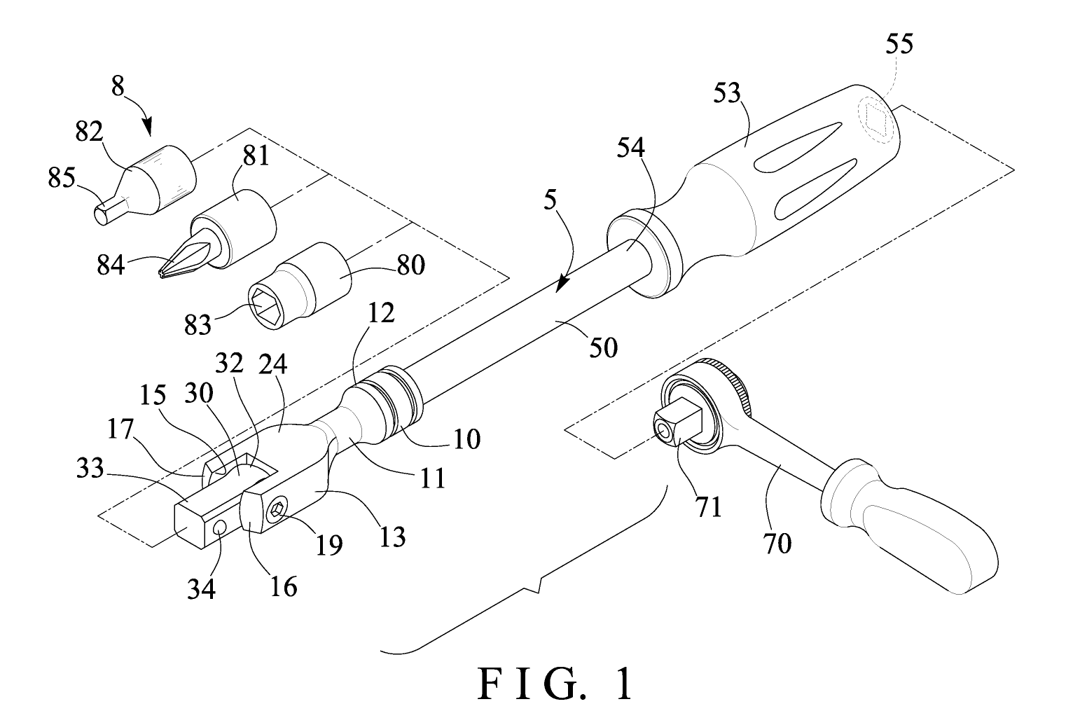

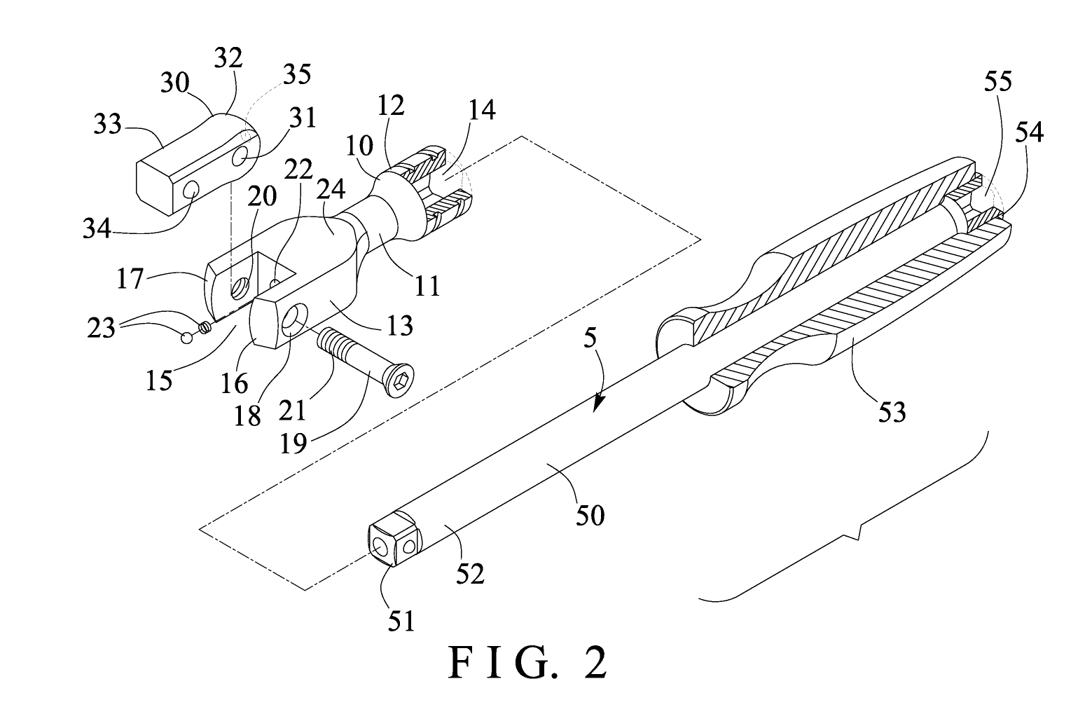

Referring to the drawings, and initially to FIGS. 1-4, a driving tool extension or combination in accordance with the present invention comprises a driving tool shank 10 including a relatively decreased or narrowed neck portion 11 formed or defined or provided between a first or receiving or engaging end portion 12 and a second or adapting or coupling end portion 13, and it is preferable, but not necessary that the ratio of the length (L, FIG. 4) to the outer diameter (D) of the narrowed neck portion 11 (L/D) is less than five (5). The driving tool shank 10 includes an engaging hole 14 formed or provided in the first or engaging end portion 12 thereof and having a non-circular cross section for selectively engaging with a driving tool device 5 and for allowing the driving tool shank 10 to be suitably driven or rotated by the driving tool device 5.

The driving tool shank 10 includes a notch 15 formed or provided in the second or coupling end portion 13 thereof and formed or defined between two ears or flaps 16, 17, and includes a through hole 18 formed or provided in the one or first flap 16 and communicating with the notch 15 of the driving tool shank 10 for slidably receiving or engaging with a fastener or pivot shaft 19, and a screw hole 20 formed or provided in the other or second flap 17 and also communicating with the notch 15 of the driving tool shank 10 and aligned with the through hole 18 of the driving tool shank 10 for threading or engaging with the threaded end portion 21 of the pivot shaft 19 and for attaching or mounting or securing the pivot shaft 19 to the flaps 16, 17 of the driving tool shank 10 and for allowing the pivot shaft 19 to be engaged through the notch 15 and straddled or supported between the flaps 16, 17 of the driving tool shank 10.

A driving adapter 30 includes an orifice 31 formed in the one or first end portion 32 thereof for pivotally or rotatably receiving or engaging with the pivot shaft 19 and for pivotally or rotatably attaching or mounting or securing the driving adapter 30 to the second or coupling end portion 13 of the driving tool shank 10 and for allowing the driving adapter 30 to be pivoted or rotated relative to the driving tool shank 10, and the driving adapter 30 includes a driving stud 33 for selectively engaging with a follower or driving head or driving member 8, such as socket members 80, 81, 82 (FIGS. 1, 3, and 17-18) and for driving or rotating the driving member 8, and includes a spring-biased detent 34 formed or provided in the driving stud 33 for engaging with the driving member 8 and for anchoring or retaining or positioning the driving member 8 to the driving adapter 30, and includes a recess 35 formed in the one or first end portion 32 of the driving adapter 30 and located or directed or faced away from the driving stud 33.

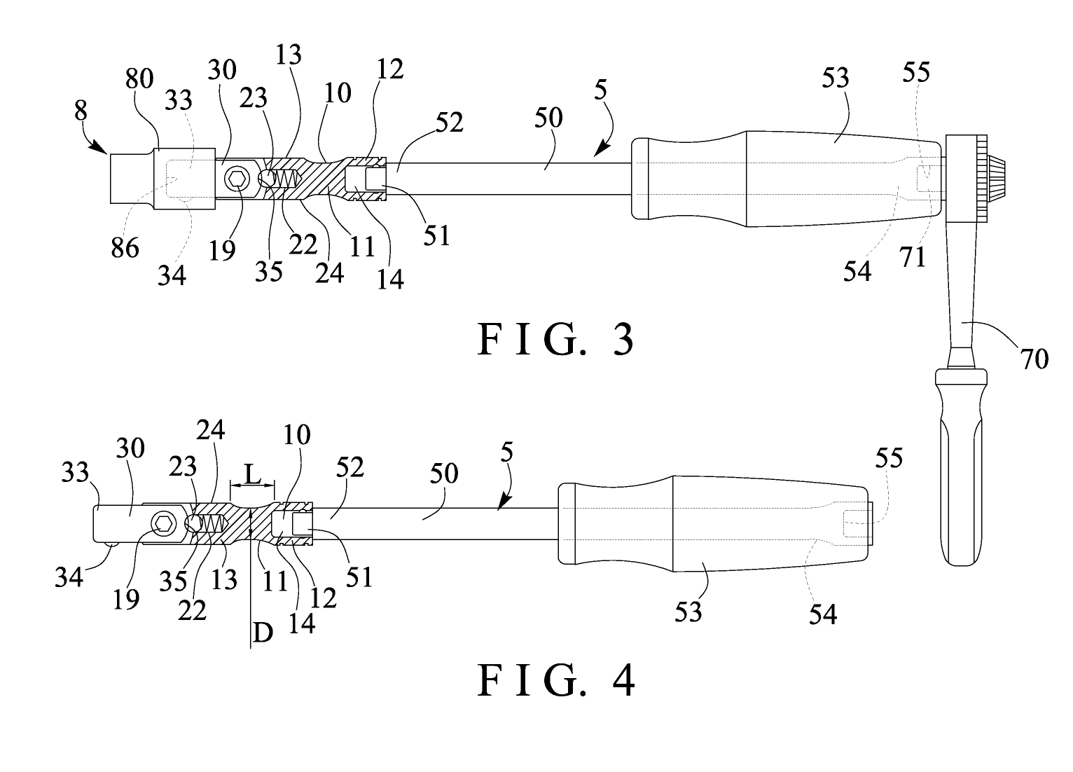

The driving tool shank 10 further includes a cavity 22 formed therein and provided and located between the flaps 16, 17 and also communicating with the notch 15 of the driving tool shank 10 for receiving or engaging with a spring-biased projection 23 which is partially extendible or engageable into the notch 15 of the driving tool shank 10, best shown in FIGS. 3-4 and 17-19, for selectively engaging with the recess 35 of the driving adapter 30 (FIGS. 3-4, 17) and for anchoring or retaining or positioning the driving adapter 30 to the driving tool shank 10 at the required or selected position, such as at a required or selected position where the driving adapter 30 is aligned with or in line with or parallel to the driving tool shank 10, and the spring-biased projection 23 is also selectively engageable with the other or side portion of the one or first end portion 32 of the driving adapter 30 (FIG. 18) for anchoring or retaining or positioning the driving adapter 30 to the driving tool shank 10 at the other position. It is preferable that the driving tool shank 10 includes two opposite flat surfaces 24 formed or provided thereon.

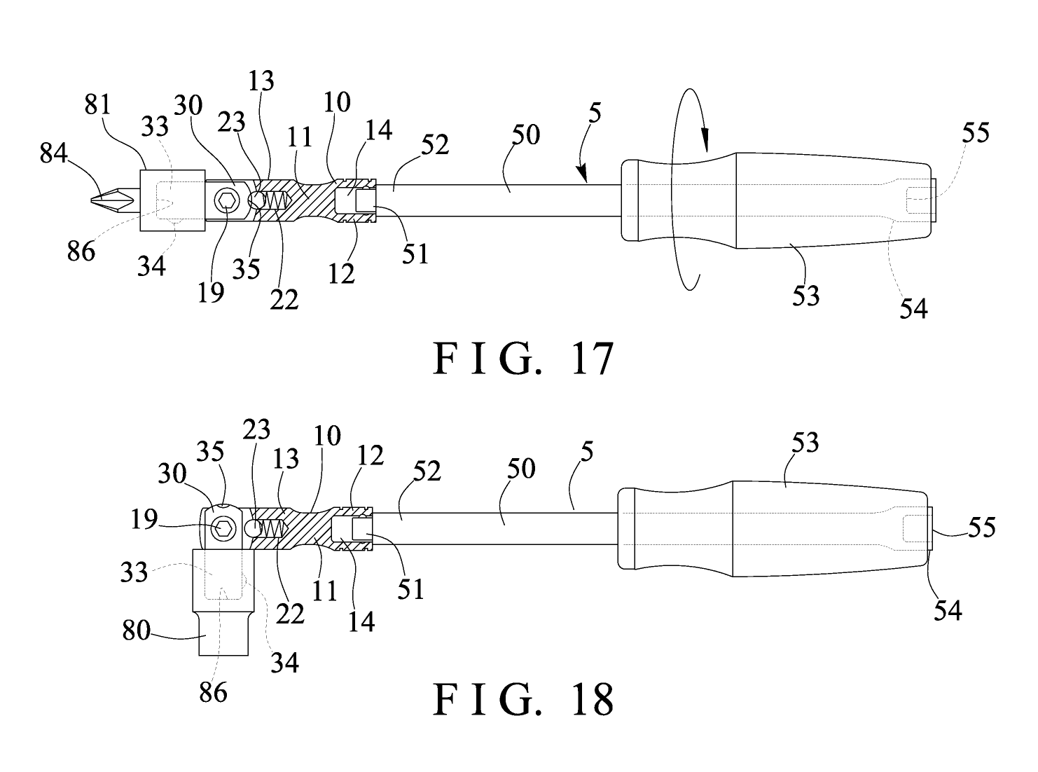

As shown in FIG. 1, the driving member 8, such as the socket member 80, 81, 82 may include a hexagonal socket opening 83 formed in the socket member 80, or may include a screw bit 84 formed or provided on the other socket member 81 (FIGS. 1, 17), or may include a hexagonal driving element or stud 85 on the further socket member 82 for selectively engaging with the fasteners or other driven tool members or extensions or elements (not illustrated) and for driving or rotating the fasteners or other driven tool extensions or members or elements. The socket members 80, 81, 82 each may include a non-circular engaging hole 86 formed or provided therein for selectively engaging with the corresponding non-circular driving stud 33 and for allowing the socket members 80, 81, 82 to be suitably and effectively driven or rotated by the driving stud 33.

The driving tool device 5 includes a driving stem 50 having a driving stud or head 51 formed or provided on the one or first end portion 52 thereof and having a non-circular cross section for selectively engaging with the corresponding non-circular engaging hole 14 of the driving tool shank 10 and for allowing the driving tool shank 10 to be selectively pivoted or rotated or driven by the driving stem 50 of the driving tool device 5, and includes a hand grip 53 formed or provided on the other or second end portion 54 thereof and made or formed with soft or resilient or spongy materials for allowing the hand grip 53 to be comfortably gripped or grasped or held by the user, and includes an engaging aperture 55 formed or provided in the other or second end portion 54 thereof for selectively engaging with a driver member or stud or head or shank 71 of another driving tool mechanism 70, such as the driving wrench 70 or the like (FIGS. 1, 3).

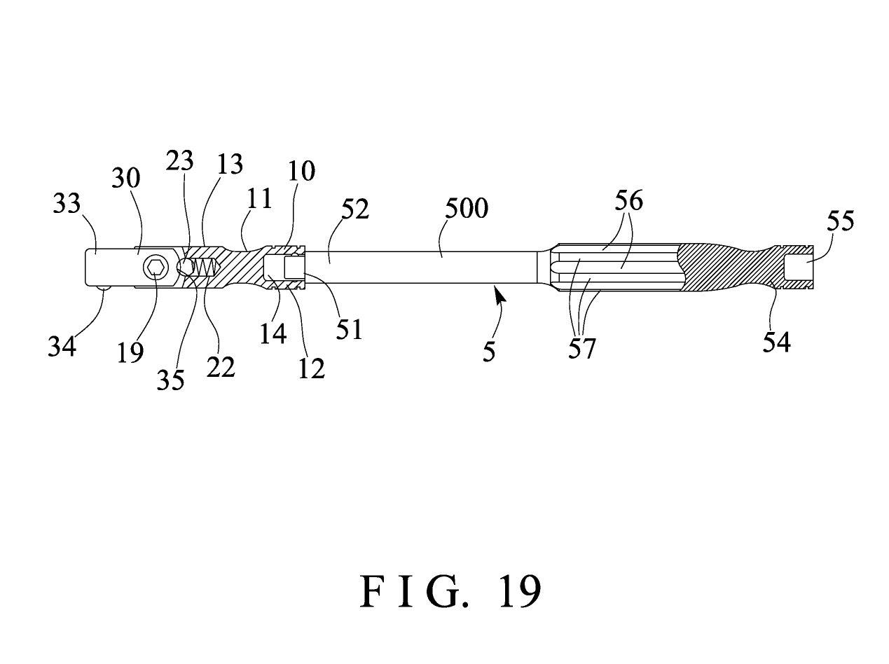

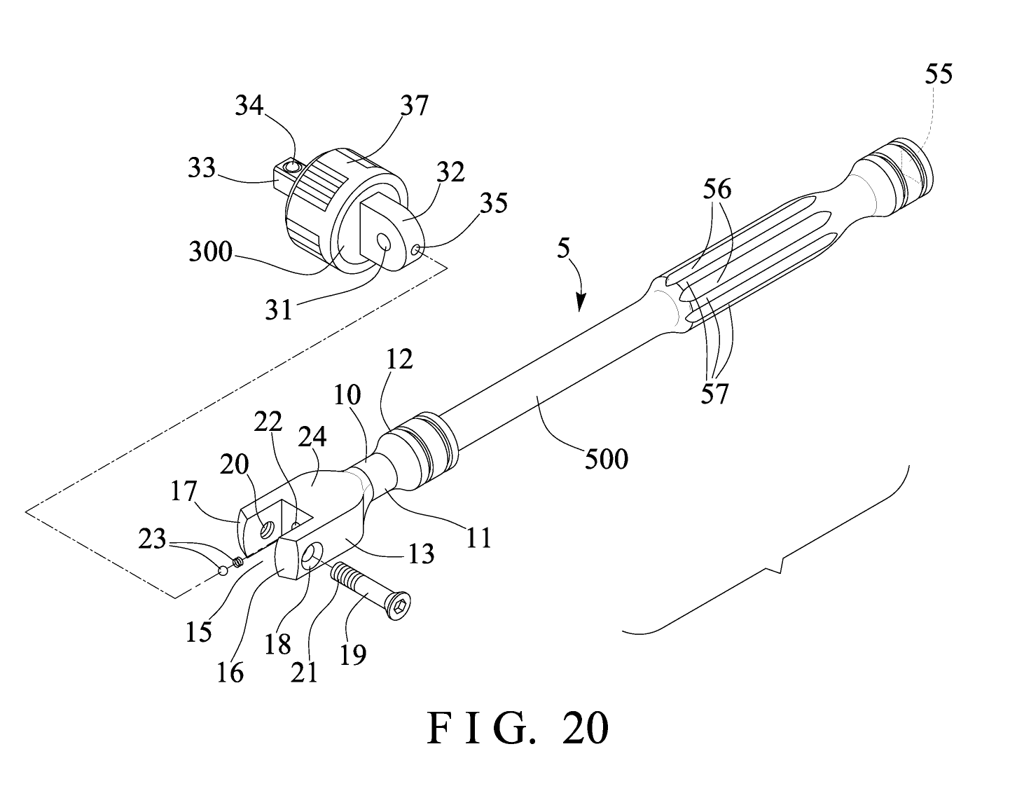

As shown in FIGS. 19, 20, without the hand grip 53 as shown in FIGS. 1-4, the driving stem 500 of the driving tool device 5 may include one or more longitudinal slots or channels or recesses or grooves 56 formed or provided in the other or second end portion 54 thereof for forming or defining one or more longitudinal bulges or ridges or swellings or ribs 57 on the other or second end portion 54 thereof and for being frictionally engaged with and gripped or grasped or held by the user and for allowing the driving stem 500 of the driving tool device 5 to be suitably and effectively driven or rotated by the user with the ribs 57 and/or the grooves 56 of the driving stem 500 of the driving tool device 5. As shown in FIG. 20, the driving adapter 300 may include a ratchet cartridge or mechanism 37 formed or provided thereon for controlling the driving direction of the driving stud 33.

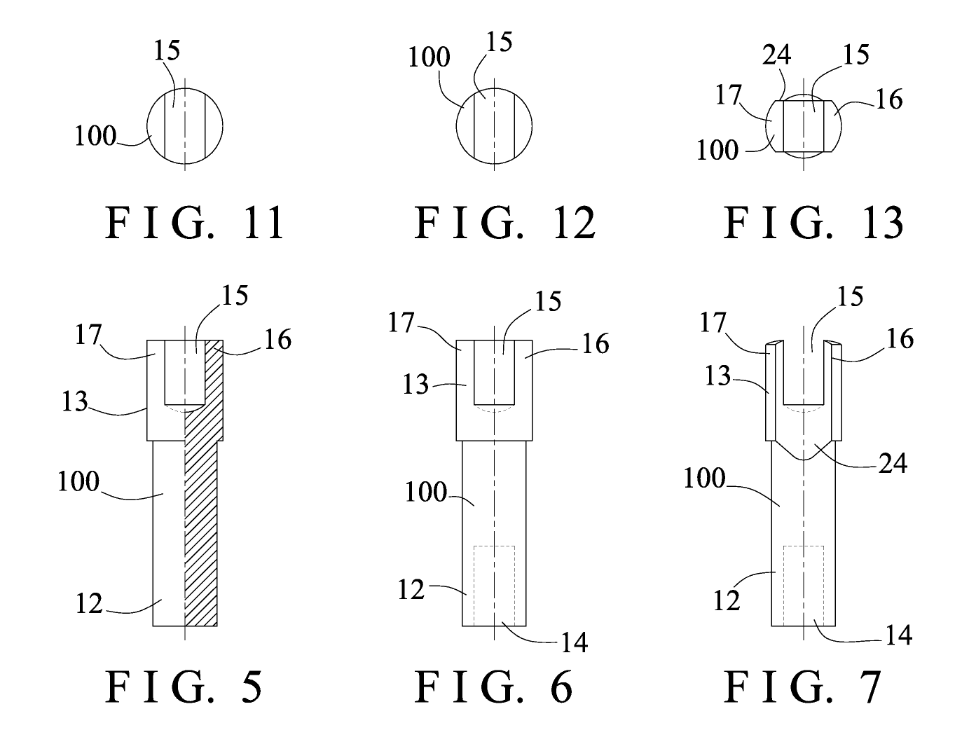

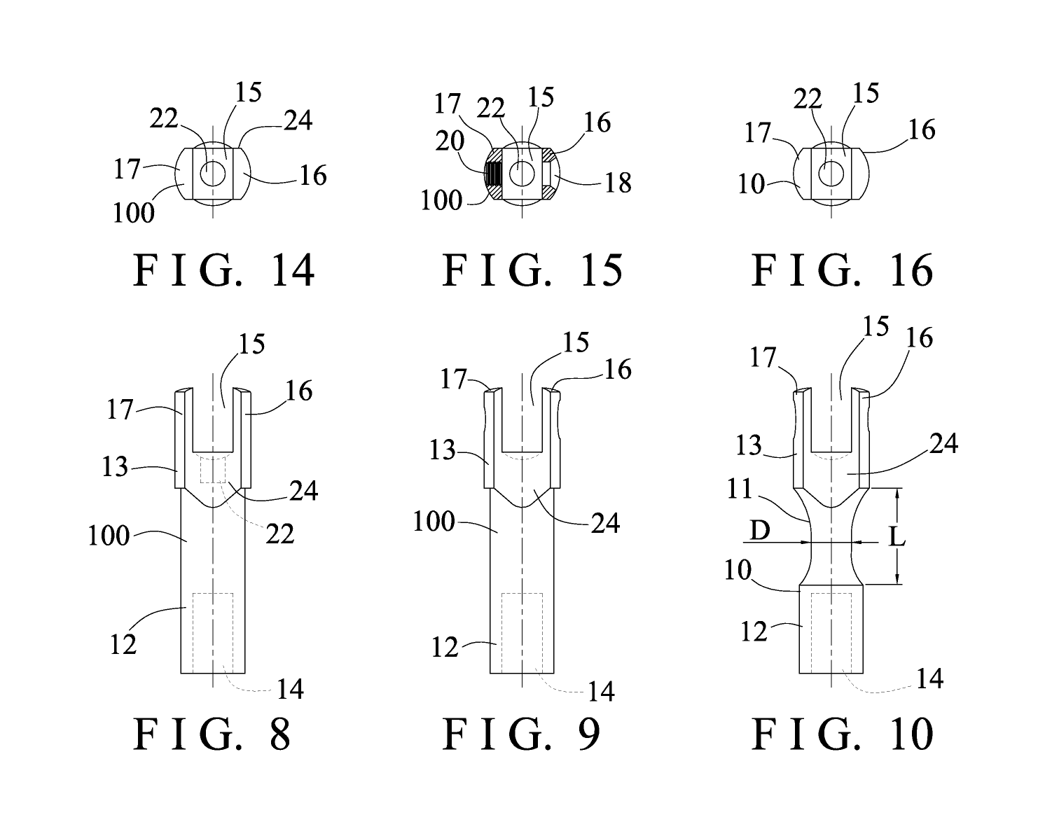

As shown in FIGS. 5-16, illustrated are the manufacturing or formation or manufacturing procedures for the driving tool shank 10. For example, as shown in FIGS. 5 and 11, a rod member or prototype 100 is used for forming or manufacturing the driving tool shank 10 and is first cut or milled to form the notch 15 in the second or coupling end portion 13 of the prototype 100 and to define the flaps 16, 17 on the prototype 100, and is then cut or milled or drilled to form the engaging hole 14 in the first or engaging end portion 12 of the prototype 100 (FIG. 6), and is then cut or milled or ground to form the two opposite flat surfaces 24 on the prototype 100 (FIGS. 7, 13), and is then drilled to form the cavity 22 in the prototype 100 (FIGS. 8, 14), and is then drilled to form the through hole 18 and the screw hole 20 in the flaps 16, 17 (FIGS. 9, 15), and is then cut or milled or ground to form the narrowed neck portion 11 and thus to form the driving tool shank 10 (FIGS. 10, 16).

It is to be noted that the driving stud 33 of the driving adapter 30 may be used to selectively engage with either of the socket members 80, 81, 82 (FIGS. 1, 3, and 17-18) of the driving member 8 and to drive or rotate the fasteners or other driven tool extensions or members or elements with the driving member 8. As shown in FIG. 17, the socket member 81 may be driven or rotated with the driving tool shank 10 and the driving stem 50 of the driving tool device 5 by gripping or grasping or holding the hand grip 53 of the driving stem 50 of the driving tool device 5. As shown in FIG. 18, the socket member 80 and the driving adapter 30 may be pivoted or rotated relative to the driving tool shank 10 to the other angular directions or locations. As shown in FIG. 3, the driver shank 71 of the driving tool mechanism 70 may be engaged with the engaging aperture 55 of the driving stem 50 of the driving tool device 5 for driving or rotating the driving member 8.

Accordingly, the driving tool combination in accordance with the present invention includes an improved structure or configuration for easily and readily and effectively rotating or driving or operating the fasteners or other tool extensions or members or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A driving tool combination comprising:
a driving tool shank including a first end portion and a second end portion, and including a non-circular engaging hole formed in said first end portion of said driving tool shank, and including a notch formed in said second end portion of said driving tool shank for forming and defining a first flap and a second flap, said notch of said driving tool shank being located between said flaps, said driving tool shank including a through hole formed in said first flap and communicating with said notch of said driving tool shank, and including a screw hole formed in said second flap and communicating with said notch of said driving tool shank and aligned with said through hole of said driving tool shank, and including a cavity formed in said driving tool shank and located between said flaps and communicating with said notch of said driving tool shank,
a pivot shaft engaged in said through hole of said first flap of said driving tool shank, and including a threaded end portion engaged with said screw hole of said second flap of said driving tool shank for attaching said pivot shaft to said flaps of said driving tool shank,
a driving adapter including an orifice formed in a first end portion thereof for receiving and engaging with said pivot shaft and for pivotally mounting said driving adapter to said second end portion of said driving tool shank and for allowing said driving adapter to be rotated relative to said driving tool shank, and including a recess formed in said first end portion of said driving adapter, said driving adapter including a non-circular driving stud,
a driving member including a non-circular engaging hole formed therein for engaging with said non-circular driving stud and for allowing said driving member to be rotated and driven by said driving stud,
said driving stud including a spring-biased detent for engaging with said driving member and for anchoring said driving member to said driving adapter,
a spring-biased projection engaged in said cavity of said driving tool shank and extendible into said notch of said driving tool shank for engaging with said recess of said driving adapter and for anchoring said driving adapter to said driving tool shank at a selected position, and
a driving tool device including a driving stem having a non-circular driving head provided on a first end portion of said driving stem for engaging with said engaging hole of said driving tool shank and for allowing said driving tool shank to be rotated and driven by said driving stem of said driving tool device.

2. The driving tool combination as claimed in claim 1, wherein said driving tool device includes a hand grip provided on a second end portion of said driving stem.

3. The driving tool combination as claimed in claim 1, wherein said driving tool device includes an engaging aperture formed in a second end portion of said driving stem, and a driving tool mechanism includes a driver shank for engaging with said engaging aperture of said driving tool device.

4. The driving tool combination as claimed in claim 3, wherein said driving tool mechanism is selected from a driving wrench.

5. The driving tool combination as claimed in claim 1, wherein said driving member is selected from a socket member.

6. The driving tool combination as claimed in claim 5, wherein said socket member includes a hexagonal socket opening formed in said socket member.

7. The driving tool combination as claimed in claim 5, wherein said socket member includes a screw bit provided on said socket member.

8. The driving tool combination as claimed in claim 5, wherein said socket member includes a hexagonal driving stud provided on said socket member.

9. The driving tool combination as claimed in claim 1, wherein said driving tool device includes at least one longitudinal groove formed in a second end portion of said driving stem for forming and defining at least one longitudinal rib on said second end portion of said driving stem.

10. The driving tool combination as claimed in claim 1, wherein said driving tool shank includes a narrowed neck portion formed between said first and said second end portions of said driving tool shank, and said narrowed neck portion of said driving tool shank includes a ratio of a length of said narrowed neck portion to an outer diameter of said narrowed neck portion less than five.
